(19) United States
(12) Patent Application Publication
(10) Pub. No.: US 2015/0371033 A1
(43) Pub. Date: Dec. 24, 2015

(54) String and Password Generation from Regular Expressions

(71) Applicant: Microsoft Corporation, Redmond, WA (US)

(72) Inventors: Margus Veanes, Bellevue, WA (US); Rani Abdellatif, Kirkland, WA (US); Jason Paul Lockhart, Issaquah, WA (US); Patrick McFalls, Redmond, WA (US)

(21) Appl. No.: 14/313,673

(22) Filed: Jun. 24, 2014

(51) Int. Cl. G06F 21/46; G06F 17/18

(52) U.S. Cl. CPC G06F 21/46; G06F 17/18

(57) ABSTRACT

Technologies are described herein for generating uniformly random passwords by the use of regular expressions. One or more regular expressions are used to define a constraint on a string or password. The regular expressions are processed into one or more symbolic finite automata (SFA). The one or more SFAs are exposed to a combination of operations to produce a determinized, minimized SFA. Provided techniques generate probability data associated with individual state transitions of the SFA, and optionally, probability data is generated for one or more binary decision diagrams (BDD). Passwords or strings can be generated by traversing the SFA using the probability data. In some embodiments, the process for selecting characters at each state transition of the determinized, minimized SFA may utilize a binary decision diagram (BDD). Techniques disclosed herein also minimize SFAs by use of an over-approximation method.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

To increase the security of sensitive data, many types of computing systems require the use of password constraints. For example, some systems impose constraints that require a password be a particular length, include special characters, have certain characters at specific positions or include a particular character combination. Although the introduction of such constraints may provide a few benefits, password constraints also introduce a number of drawbacks. For instance, when a user is required to follow a set of constraints to derive a password, the resulting password is not likely to be uniformly random, as users have a tendency to reuse words, focus on specific characters or follow patterns that may compromise the security of a system.

When computers are used to generate passwords, the introduction of constraints creates other complications. In one example of an existing system, a password may be generated by starting with a random string and testing the random string to determine if it conforms to a set of desired constraints. This approach has a number of drawbacks. First, this approach is computationally inefficient, particularly when used with long passwords. In addition, existing methods are also inefficient because a large number of random strings are likely to be tested and rejected before the process yields a fully conforming password. Also, techniques used by existing systems may also not produce a result that is uniformly random.

It is with respect to these and other considerations that the disclosure made herein is presented.

### SUMMARY

Technologies are described herein for generating uniformly random passwords by the use of regular expressions. In embodiments disclosed herein, one or more regular expressions may be used to define a constraint of a string or password. For instance, regular expressions may be used to define one or more constraints that limit the length of a password, dictate the use of certain characters, require the use of a number at specific positions, etc. Techniques described herein process the regular expressions into one or more symbolic finite automata. If multiple symbolic finite automata are used, they are productized to create a composed symbolic finite automaton. If needed, techniques disclosed herein also apply determinization and minimization operations to the one or more symbolic finite automata and/or the composed symbolic finite automaton. In addition, techniques described herein associate a formula defining a set of valid characters with individual state transition of the composed symbolic finite automaton.

Techniques disclosed herein also generate probability data that is associated with individual state transitions of the composed symbolic finite automaton. In one embodiment, a probability associated with a given state transition is based on the number of valid characters of the given state transition and the number of valid characters of the state transitions succeeding the given state transition. The probability associated with the given state transition is also based on the number of valid characters of a second state transition that shares an originating state with the given state transition, and the number of valid characters of the state transitions subsequent to the second state transition. In another embodiment, as will be described in more detail below, the generation of any given probability may be based on the number of valid strings that are generated when following either state transition. In other embodiments, as explained in more detail below, the probability data may be based on other calculations. For instance, a binary decision diagram (BDD) may be associated with state transitions of the symbolic finite automaton. In such embodiments, BDDs may be used to calculate the probability data. Stated differently, let “|q|” denote the number of all strings accepted starting from state q and let “|p−>q|” denote the number of characters in the BDD of the transition from state p to state “q.” Then the probability associated with the transition from p to q is “|p−>q|*|q|/|p|”.

A password or string is then generated by a process that traverses through the structure of the composed symbolic finite automaton. In this process, individual characters are selected at each state transition in accordance with the associated formula of valid characters. By using techniques disclosed herein, the selection of characters at each state transition is uniformly random. When the process encounters a state with more than one exiting state transition, the generated probability data is used to select one exiting state transition. As will be described in more detail below, use of the probability data to select state transitions provides an efficient way to generate a uniformly random password or string that conforms to the regular expressions. In addition, the techniques described herein do not require the use of a random baseline string, which may be biased with particular characters or old patterns.

According to various embodiments, the above-described process for selecting characters at each state transition may utilize a BDD. Generally described, a BDD may be used to represent valid characters that are associated with a state transition of a symbolic finite automaton. Techniques disclosed herein generate probability data that is associated with individual state transitions of the BDD. To select an individual character, the process traverses through the structure of the BDD and records individual bits in the passing of each state transition. The recorded bits ultimately form a bit combination representing the individual character. In traversing the BDD, when the process encounters a state with more than one exiting state transition, the generated probability data is used to select one exiting state transition. The use of the probability data to select state transitions of a BDD provides yet another mechanism to generate a uniformly random password or string. Stated differently, let “|q|” denote the number of accepted {0,1} bit sequences from node q of a BDD and suppose there are transitions from node q to q0 and q1 corresponding to the next bit being 0 or 1 respectively. Then, “|q|=|q0|+|q1|” and the probability of choosing 0 is “|q0|/|q|”.

According to various embodiments, techniques are provided herein for minimizing complex symbolic finite automata. The techniques for minimizing symbolic finite automata include the selection of a set of states, which may include a set of final states or a set of non-final states. By following the transitions from the selected states, techniques disclosed herein define partitions between various states of the SFA. An over-approximation technique is applied to the states in each partition to determine the states and state transitions of a minimized symbolic finite automaton. Techniques disclosed herein allow for the minimization of a symbolic finite automaton without the need to calculate minterms.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings. It should be appreciated that the above-described subject matter may also apply to the generation of any desired string or data that follows one or more constraints. Although the techniques and some of the examples disclosed herein describe the generation of passwords, it can be appreciated that the techniques disclosed herein may also apply to the generation of strings or any other combination of text characters.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram representing example components for generating a password from regular expressions, in accordance with some embodiments;

FIG. 2 is a flow diagram illustrating an example method for generating a password from regular expressions, in accordance with some embodiments;

FIG. 3A is an example symbolic finite automaton of a first password constraint;

FIG. 3B is an example symbolic finite automaton of a second password constraint;

FIG. 4A is a composed symbolic finite automaton based on the symbolic finite automaton shown in FIGS. 3A and 3B;

FIG. 4B is another composed symbolic finite automaton based on the symbolic finite automaton shown in FIGS. 3A and 3B;

FIG. 4C is a minimized symbolic finite automaton based on the symbolic finite automaton shown in FIGS. 3A and 3B;

FIG. 5 is a binary decision diagram associated with a state transition of the minimized symbolic finite automaton shown in FIG. 4C;

FIG. 6 is a flow diagram illustrating an example routine for minimizing a symbolic finite automaton, in accordance with some embodiments;

FIGS. 7A-7E show several phases of an example symbolic finite automaton that is minimized using the routine illustrated in FIG. 6, in accordance with some embodiments; and

FIG. 8 is a computer architecture diagram showing an illustrative computer hardware architecture for a computing system capable of implementing the embodiments presented herein.

### DETAILED DESCRIPTION

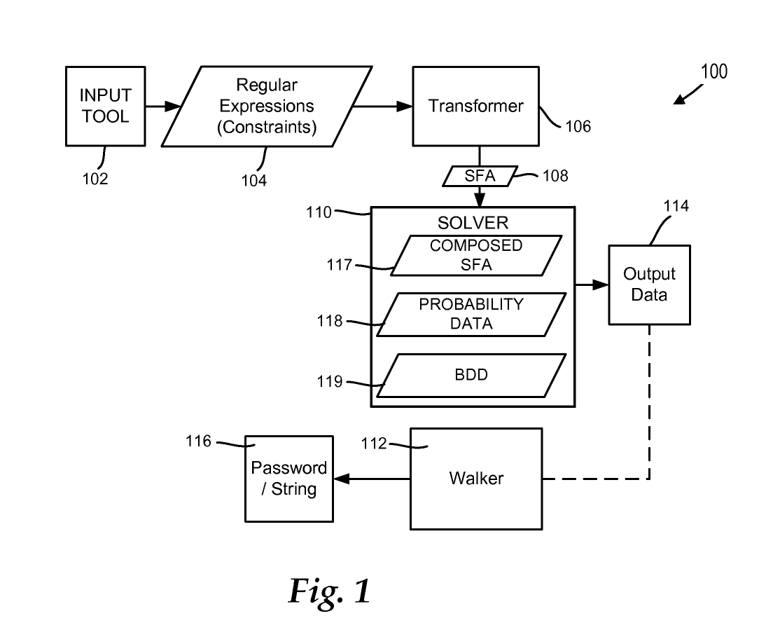

Technologies are described herein for generating uniformly random passwords by the use of regular expressions. One or more regular expressions are used to define a constraint on a string or password. The regular expressions are processed into one or more symbolic finite automata (SFA). The one or more SFAs are processed by a combination of operations to produce a determinized, minimized SFA. Probability data is associated with individual state transitions of the SFA, and optionally, probability data is associated with individual state transitions of one or more binary decision diagrams (BDD). Passwords or strings can be generated by traversing the SFA using the probability data. As will be described in more detail below, embodiments disclosed herein may optionally utilize a BDD for selecting characters of a password. In addition, embodiments disclosed herein utilize techniques for minimizing complex SFAs. By the use of the techniques described herein, both positive and negative constraints can be processed to generate a password or string. Additional details regarding these and other aspects of the technologies presented herein will be provided below with regard to FIGS. 1-8.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for communicating, processing and transforming data representing symbolic finite automata will be described.

Turning now to FIG. 1, details will be provided regarding an illustrative operating environment and several software components provided by the embodiments presented herein. In particular, FIG. 1 shows aspects of a system 100 for generating a password 116 from regular expressions 104. As shown in FIG. 1, the example components include an input tool 102, a transformer 106, a solver 110 and a walker 112 for generating a password 116.

Generally described, the input tool 102 generates one or more regular expressions 104, which are communicated to the transformer 106. The transformer 106 processes the regular expressions 104 to generate a symbolic finite automaton 108 for each regular expression 104 provided by the input tool 102. The solver 110 then processes each symbolic finite automaton 108 by performing one or more operations which may include: determinizing, combining and minimizing each symbolic finite automaton 108.

As will be described in more detail below, the solver 110 may perform one or more of these operations in different sequences depending on the form of the symbolic finite automata produced by the transformer 106. The result of these operations produces a minimized, composed symbolic finite automaton 117. The solver 110 also generates probability data 118 associated with the state transitions of the composed symbolic finite automaton 117.

As described in more detail below, the probability data 118 can be calculated by the use of a number of various techniques. In one embodiment, the calculation of the probability data 118 is based on the number of valid characters associated with state transitions of the composed symbolic finite automaton 117. In other embodiments, the probability data 118 may be based on data generated from binary decision diagrams. In other embodiments, the probability data 118 may be based on the number of valid strings associated with particular parts of the composed symbolic finite automaton 117.

As an optional feature, the probability data 118 and data describing the composed symbolic finite automaton 117 may be serialized and stored as output data 114. To generate the password 116, the walker 112 accesses the output data 114 and utilizes the probability data 118 and data describing the composed symbolic finite automaton 117 to generate characters of the password 116. As summarized above, in techniques disclosed herein, the process for selecting characters at each state transition might utilize a BDD. In such embodiments, the solver 110 also generates probability data 118 associated with the state transitions of the BDD 119.

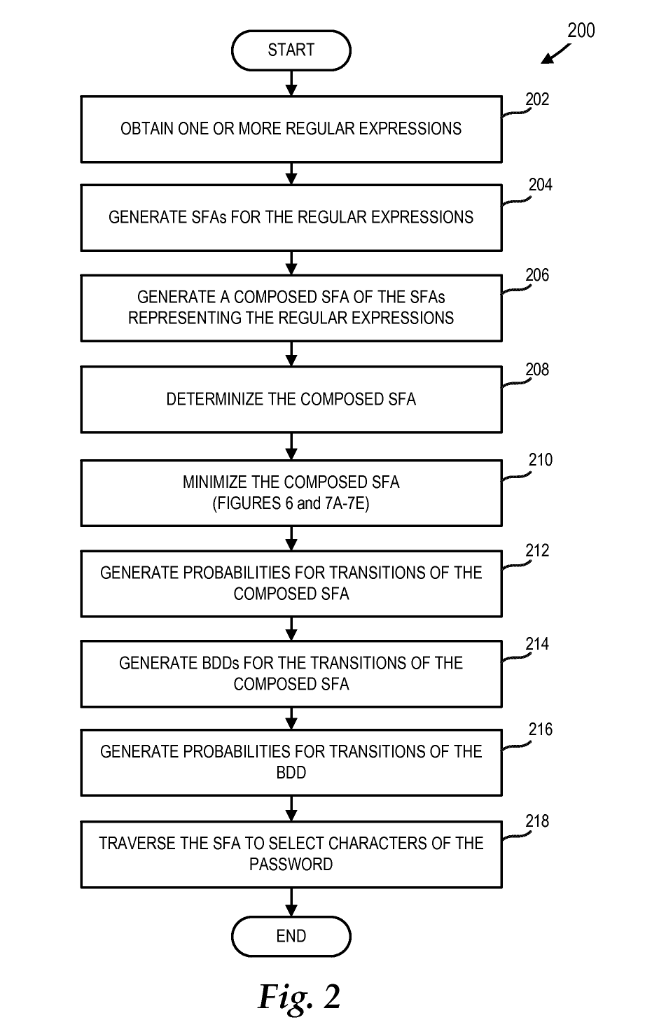

Referring now to FIG. 2, a flow diagram illustrating aspects of one illustrative routine 200 for generating a password 116 from one or more regular expressions 104 will be described. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The implementation of the various components described herein is a matter of choice dependent on the performance and other requirements of the computing device. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the FIGURES and described herein. These operations may also be performed in parallel, or in a different order than those described herein.

The routine 200 begins at operation 202 where the transformer 106 obtains one or more regular expressions 104. As summarized above, a regular expression may be used to define a constraint of a string or password. As a matter of background, a regular expression, also referred to herein as REGEX, is a sequence of characters that define text patterns. Additional background on REGEX is described in MSDN, “.NET Framework Regular Expressions,” 2009, http://msdn.microsoft.com/en-us/library/hs600312.aspx. As can be appreciated, a regular expression may be generated by a computer by the use of an input tool 102. One example of the input tool 102 includes a program referred to as a Pex tool. As can also be appreciated, techniques described herein may also process negative constraints, i.e., constraints that disallow particular text patterns, as well as positive constraints. Although regular expressions may not allow complementation, it can be readily understood that a symbolic finite automaton may allow complementation.

By way of example, a regular expression to evaluate a dashed ten digit telephone number may be represented as: “̂\d{3}-d{3}-\d{4} $”, where ̂ represents the start of the string, “\d{3}” represents any three digits (or similarly “\d{4}” represents any four digits) and $ represents the end of the string. In applying an illustrative example to the routine 200, two password constraints are provided. In a first example, a password constraint may be represented as: “̂[A-Za-z0-9]{4}$”. This first example constraint represents a password having only four (4) alpha-numeric characters. In a second example, a password constraint may be represented as: “.\d”. In this second example, the first period notes that the first position can be any character, and that the first field cannot be empty. As indicated by the “\d” phrase, the first character is followed by a digit (0-9). And last, the second period notes that the last position can be any character and that the last position cannot be empty. As can be appreciated, without a “̂” character at the beginning of this sample constraint and a “$” at the end of this sample constraint, this pattern can be in any position of a resulting string.

Next, at operation 204, the transformer 106 generates a symbolic finite automaton (SFA) for each regular expression 104. As can be appreciated, methods for generating a SFA from a regular expression is based on known algorithms for converting a standard regular expression into a finite automaton with epsilon moves. Additional information describing regular expressions and SFAs is provided in U.S. Pat. No. 8,515,891, the disclosure of which is incorporated herein by reference. As will be described in more detail below, techniques disclosed herein associate state transitions of an SFA with a formula defining valid characters of a password or string. Techniques disclosed herein use the formulas to generate probability data associated with the state transitions, and the probability data is then used to select specific characters.

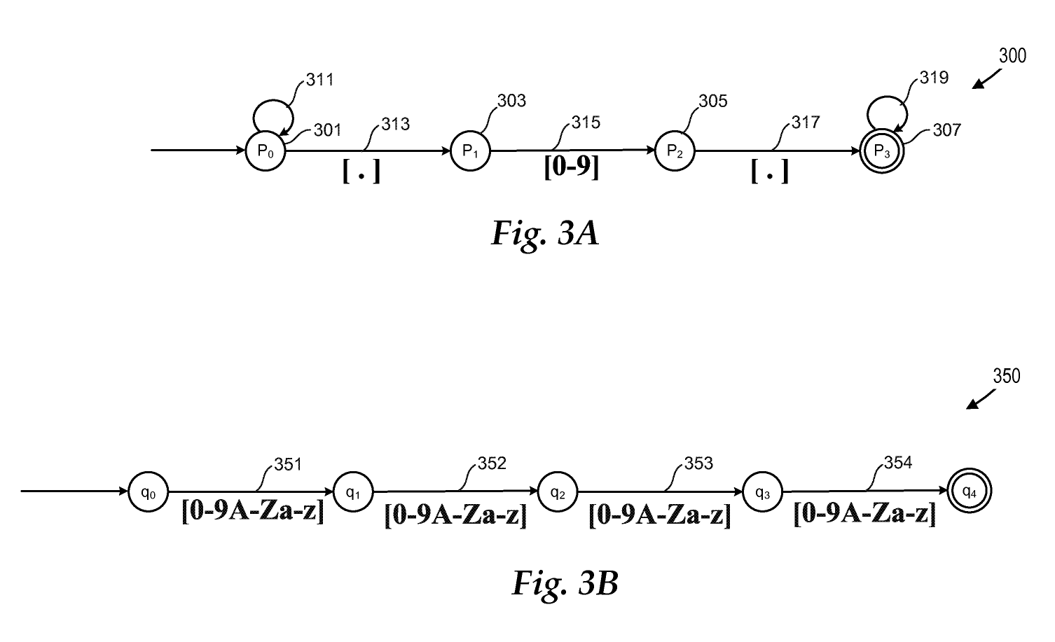

Referring to FIGS. 3A and 3B, sample SFAs that may be generated in operation 204 are provided. Specifically, the first sample SFA 300 depicted in FIG. 3A correlates to the regular expression represented as: “.\d”. As shown, state transition 313, between state 301 and state 303, is associated with the first period in the regular expression. The state transition 315, which is between state 303 and state 305, is associated with the regular expression, [0-9]. In addition, state transition 317, which is between state 305 and state 307, is associated with the second period in the regular expression. The loop transitions 311 and 319, as generally known, represent the acceptance of any character except, in loop transition 311, a character preceding the digit in this pattern, and in loop transition 319, the character following the digit.

The second sample SFA 350 is depicted in FIG. 3B correlates to the regular expression represented as: “̂[0-9A-Za-z]{4}$”. As shown, the state transitions 351-354 are each associated with a formula defining valid characters. In this example, the formula associated with each state transition represents that each character may include an alphanumeric character. More specifically, this formula specifically defines 62 valid characters for each state transition, which includes: the upper-case alphabet, the lower-case alphabet or a digit. It can be appreciated that the examples shown in FIGS. 3A and 3B are provided by way of illustration only and should not be construed as limiting. In addition, it can be appreciated that a formula associated with a state transition may be referred to as a regular expression.

Referring again to FIG. 2, after the SFAs are generated, the routine 200 proceeds to operation 206 where the solver 110 processes the individual SFAs to create the composed SFA 117. Operation 206 may involve one or more generally known techniques for productizing individual SFAs to create the composed SFA 117. Once the composed SFA 117 is generated, the routine 200 proceeds to operation 208 where the solver 110 determinizes the composed SFA 117. As can be appreciated, any known method for converting a nondeterministic SFA to a deterministic SFA can be used in operation 208. As can be appreciated, the composed SFA 117 is acyclic, i.e., loop free, as a result of the processing described herein. Such a result may be acquired even though the original individual SFAs are not acyclic.

In some embodiments, operations 206 and 208 can be arranged in a different order and the techniques disclosed herein may use all or some of the functionality of operations 206 and 208. For instance, the solver 110 may determinize the individual SFAs 108 before they are combined to form the composed SFA 117. In such an embodiment, the solver 110 may examine the individual SFAs 108 to verify if they are non-deterministic. The solver 110 would then determinize the individual SFAs 108 that are found to be non-deterministic, and skip determinizing step for individual SFAs 108 that are found to be deterministic. After the individual SFAs 108 are all found to be deterministic, the solver 110 combines the individual SFAs 108 to create the composed SFA 117.

As noted above, it can be appreciated that operations 206 and 208 are optional depending on the individual SFAs 108 that are provided by the transformer 106. For instance, the transformer 106 may generate a single deterministic SFA. In this scenario, operations 206 and 208 are not needed. In another scenario, the transformer 106 may provide multiple SFAs that may be combined to produce a deterministic composed SFA 117. Thus, it can be appreciated that the SFAs are combined in operation 206 but not determinized in operation 208. In yet another scenario, the transformer 106 may generate a single non-deterministic SFA. Thus, it can be appreciated that the single non-deterministic SFA may be determinized in operation 208 but not require the productization of operation 206.

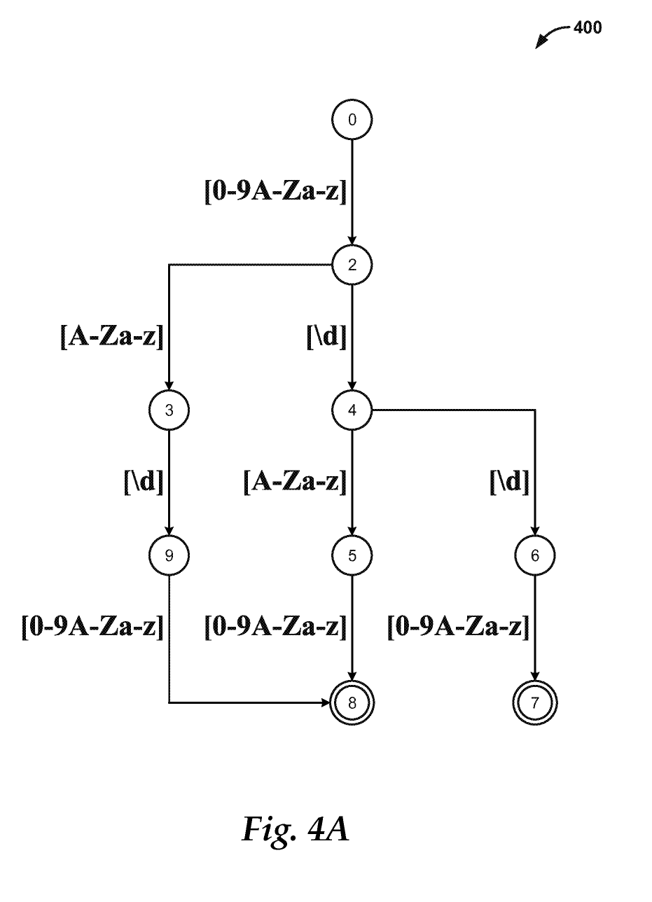

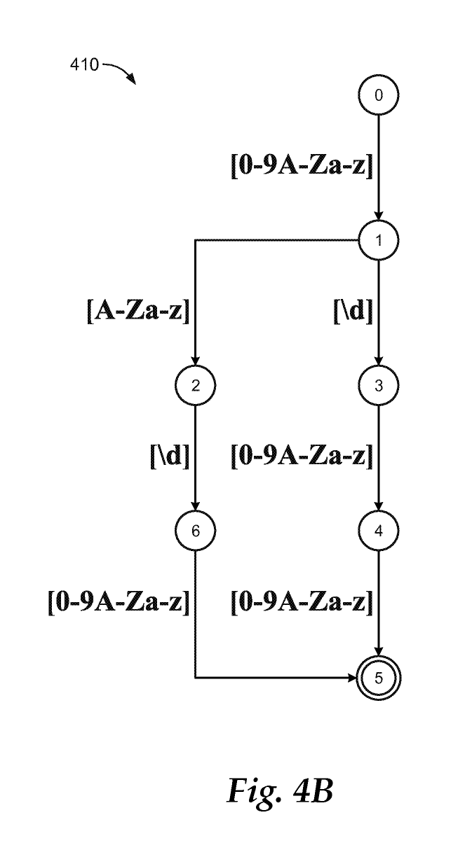

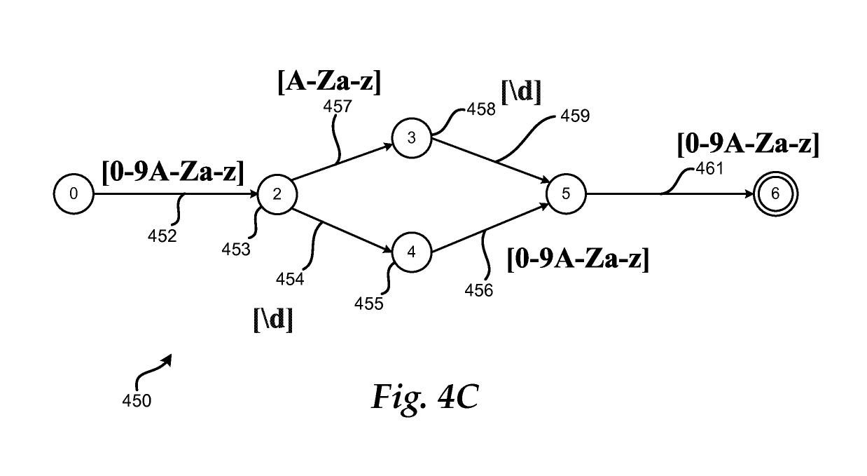

FIGS. 4A and 4B illustrate sample composed SFAs 400 and 410 that are generated by the solver 110 using operations 206 and 208. Each of the sample composed SFAs 400 and 410 are the product of the first sample SFA 300 and the second sample SFA 350 shown in FIGS. 3A and 3B. Specifically, the first sample composed SFAs 400 of FIG. 4A represents the resulting output when the individual SFAs 300 and 350 are first productized and then determinized. The second sample composed SFAs 410 of FIG. 4B represents the resulting output when the individual SFAs 300 and 350 are first determinized and then productized. These samples are shown for illustrative purposes and should not be construed as limiting.

Returning again to FIG. 2, once a deterministic SFA, e.g., the composed SFA 117, representing the desired regular expressions is generated, the routine 200 proceeds to operation 210 where the solver 110 performs a minimization process. As can be appreciated, operation 210 may involve a number of known techniques for minimizing a SFA. For example, known techniques, such as Hoperoft's algorithm or Moore's algorithm, may be used to implement operation 210.

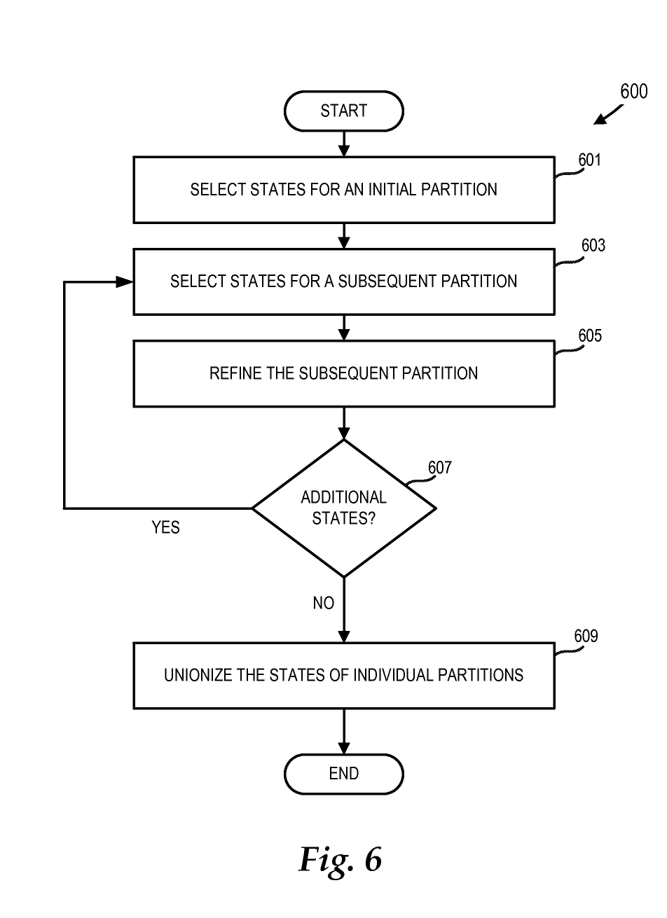

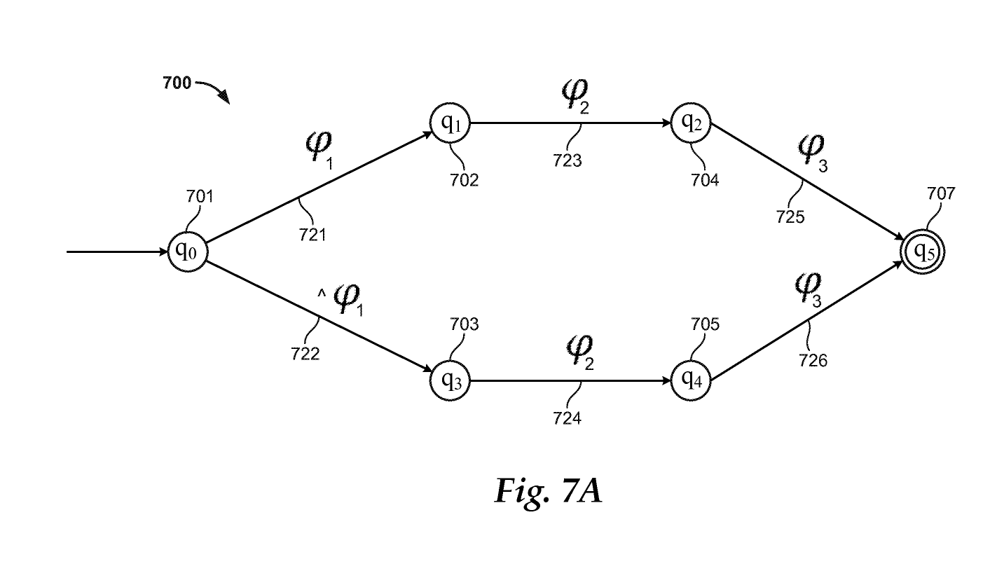

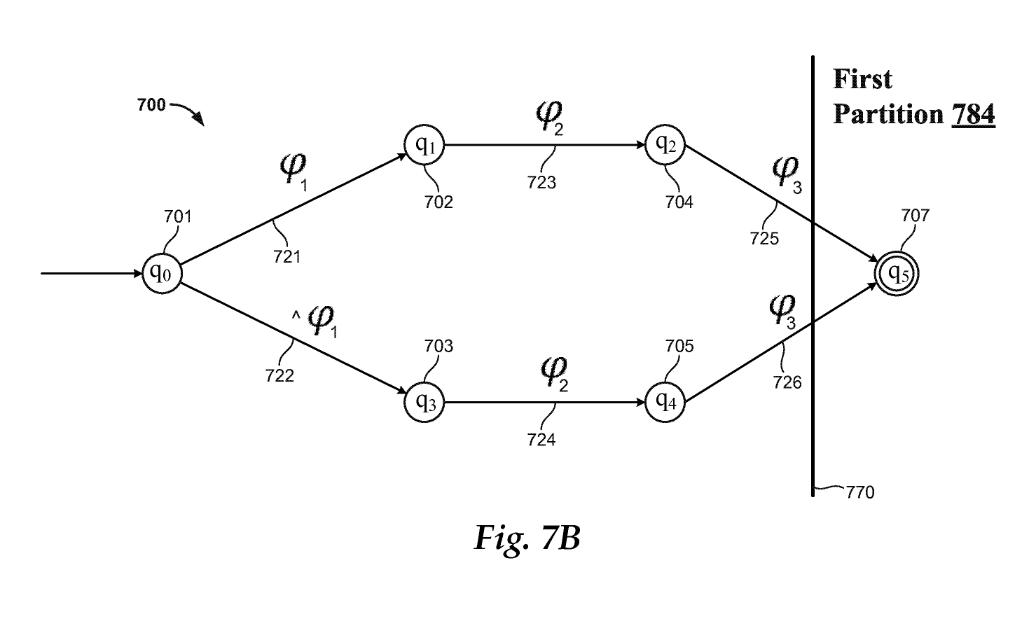

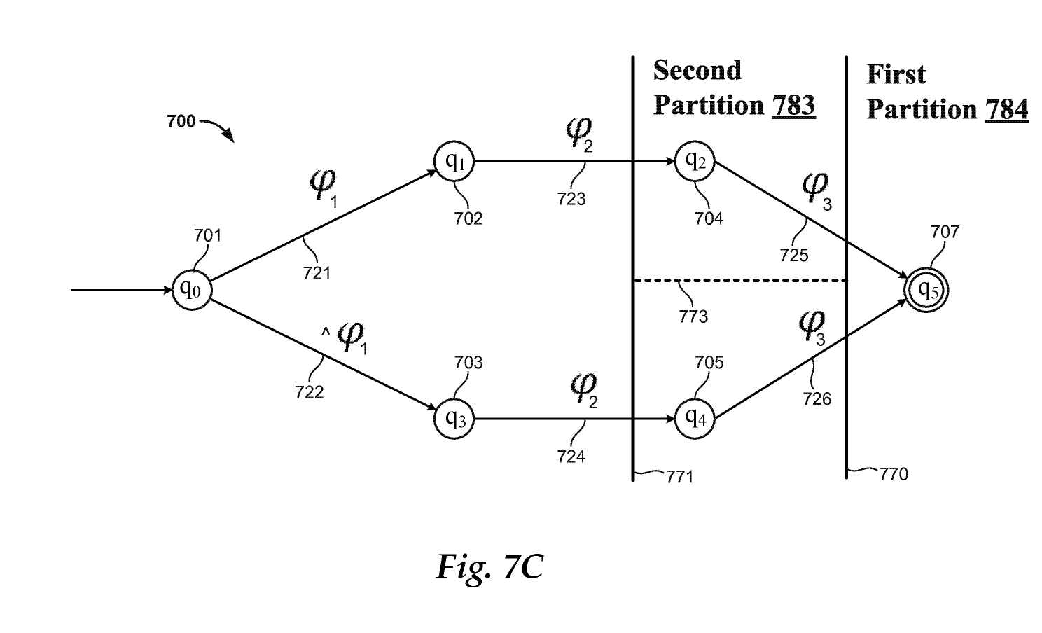

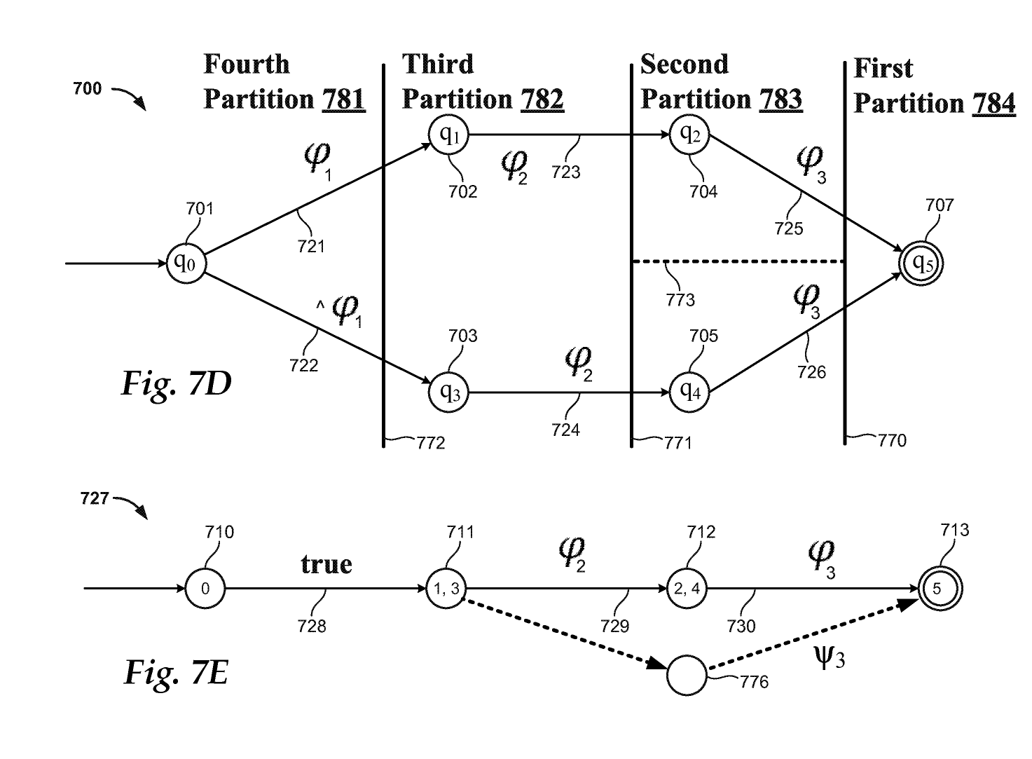

In addition, other techniques for minimizing symbolic finite automata are provided herein and described below in conjunction with FIGS. 6 and 7A-7E. The resulting product of operation 210 is a minimized, deterministic SFA that represents the desired regular expressions that were processed in operation 202. For illustrative purposes, the minimized, deterministic SFA is also referred to herein as the “minimized SFA.” Data describing the minimized SFA may be stored in memory. For illustrative purposes, the data describing the minimized SFA is also referred to herein as the composed SFA 117.

FIG. 4C illustrates one example of a minimized, deterministic SFA 450, (also referred to herein as an “example minimized SFA 450”) that may be produced by operation 210. The example minimized SFA 450 may be produced by the minimization of the first sample composed SFAs 400. Alternatively, the example minimized SFA 450 may be produced by minimizing the second sample composed SFA 410. As shown in FIG. 4C, each state transition of the minimized SFA is associated with a formula that defines one or more valid characters. The formulas presented in FIG. 4C were formed in the processing of operations 202-210. Thus, the example minimized SFA 450 is based on the two example regular expressions “.\d.” and “̂[0-9A-Za-z]{4}$”.

Returning now to FIG. 2, the routine 200 proceeds to operation 212 where solver 110 generates one or more probabilities for state transitions of a SFA. In one illustrative implementation, operation 212 is applied to the minimized SFA produced in operation 210. As explained above, each state transition of the minimized SFA is associated with a formula that defines one or more valid characters. In operation 212, a generated probability is associated with a given state transition, and the probability is based on the number of valid characters for that given state transition and the number of valid characters for subsequent state transitions.

The probability associated with the given state transition is also based on the number of valid characters of a second state transition that shares an originating state with the given state transition. The probability associated with the given state transition is also based on the number of valid characters of the state transitions subsequent to the second state transition. In operation 212, probability values may be generated for any number of the state transitions. It can be appreciated that, in one embodiment, probability values can be generated for all state transitions that share an originating state with at least one other state transition. Stated another way, let |q| denote the number of all strings accepted starting from state q and let |p−>q| denote the size of the BDD on transition “p−>q”. Then the probability associated with the transition from p to q is “|p−>q|*|q|/|p|”.

With reference to the example minimized SFA 450 of FIG. 4C, example probability equations and calculations are provided for illustrative purposes. In a first example, a probability associated with state transition 457 can be represented by the following equation: “P₂=k₁/k₁+k₂”. The variable k₁ represents the number of valid characters of state transition 457 and the number of valid characters of the state transitions 459 and 461 subsequent to state transition 457. The variable k₂ represents the number of valid characters of state transition 454 and the number of valid characters of the state transitions 456 and 461 subsequent to state transition 454. Similarly, a probability associated with state transition 454 can be represented by the following equation: “P₃=k₂/k₁+k₂”.

In applying the above-described example probability equations to the example minimized SFA 450 of FIG. 4C, given the formulas at each state transition, k₁=32,240 and k₂=38,440. As described above, the calculation of k₁ and k₂ are based on the formulas defining the valid characters of state transition 457, state transition 454 and all subsequent state transitions. In particular, k₁ is based on the number of valid characters for state transition 457, [A-Za-z], which includes 52 valid characters, all uppercase and all lower case letters. The variable k₁ is also based on the number of valid characters for the state transitions subsequent to state transition 457.

State transition 459 and state transition 461 respectively include 10 valid characters based on the formula [\d] and 62 valid characters based on the formula [0-9A-Za-z]. Thus, “k₁=52*10*62=32,240”. Similarly, state transition 454 and its subsequent state transitions produce a value of “k₂=10*62*62=38,440”.

In applying the above-described probability equations to the current example, the probability associated with state transition 457 is “P₂=32,240/(32,240+38,440)=0.456”. In addition, the probability associated with state transition 454 is “P₃=38,440/(32,240+38,440)=0.544”. These examples are provided by way of illustration only and should not be construed as limiting. As will be described in more detail below, the calculated probabilities are used by the walker 112 to traverse the structure of the minimized SFA to select characters of a string or password. The probabilities of FIG. 4C may also be represented as “|q₂−>q₃|=52, |q₃−>q₅|=10”, “|q₅−>q₆|=62”, “|q₄−>q₅|=62”, “|q₂−>q₄|=10”, “|q₀−>q₂|=62”. Table 1 illustrates the corresponding calculations.

TABLE 1

|q₆| = 1 (the empty string is accepted from q6 so |q6| = 1),
|q₅| = 62 * |q₆| = 62,
|q₃| = 10 * |q₅| = 620
|q₄| = 62 * |q₅| = 62 * 62 = 3844
|q₂| = (52 * |q₃|) + (10 * |q₄|) = 32240 + 38440 = 70680.
(i.e., k₁ = 32240 and k₂ = 38,440)
|q₀| = 62 * |q₂| = 4,382,160
The probability of transition 457 (q₂−>q₃) is |q₂−>q₃|*|q₃|/|q₂| = 52*620/70680 = 0.456

Referring again to FIG. 2, the routine 200 may include operation 214 where the solver 110 generates a binary decision diagram (BDD) for individual state transitions of a minimized SFA, such as the minimized SFA produced in operation 210. As summarized above, a formula defining valid characters may be associated with individual state transitions of an SFA. In some embodiments, the formula defining valid characters of a state transition may be modeled in a binary decision diagram (BDD). As is known, a BDD is a directed acyclic graph having states (nodes) at different orders (levels), and having state transitions between the nodes. Any generally known technique for generating a BDD from any formula defining valid characters or any regular expression may be used in operation 214.

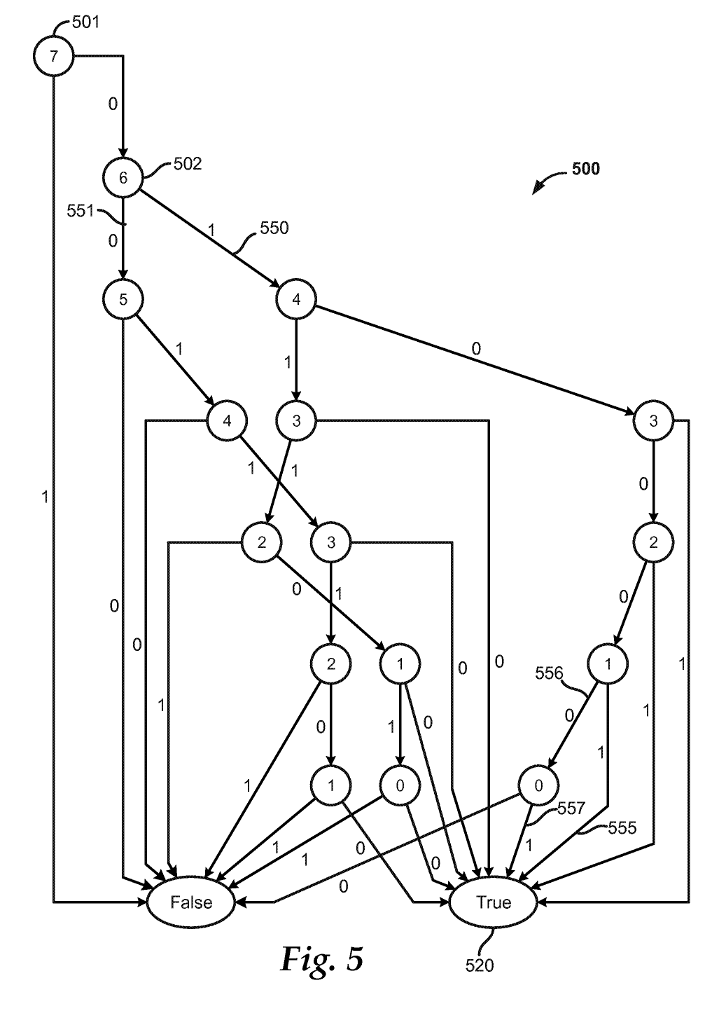

An example BDD 500 is shown in FIG. 5. The example BDD 500 represents the regular expression, [0-9A-Za-z]. As shown in FIG. 4C, this regular expression, [0-9A-Za-z], defines the valid characters for state transition 452, state transition 456, and state transition 461 of the example minimized SFA 450. As can be appreciated, each route through the BDD 500 from the first state 501 to the final true state 520 creates a bit pattern that corresponds to a character that comports with the regular expression [0-9A-Za-z]. This example is provided by way of illustration only and should not be construed as limiting, as any BDD and any method for generating a BDD are within the scope of the techniques described herein. It can be appreciated that techniques disclosed herein may not use a BDD, or a BDD may be associated in any one or all transitions of an SFA.

Referring again to FIG. 2, the routine 200 proceeds from operation 214 to operation 216 where the solver 110 generates probabilities for the state transitions of the BDDs generated in operation 214. As summarized above, each state transition of a BDD is associated with a bit that is used to form a bit pattern of a character. For all routes of the BDD that lead to a “true” final state, the resulting bit pattern of each route represents a character that comports with an associated formula or regular expression. Thus, as a route of the BDD is traced from the first state to the “true” final state, each state transition provides a bit, and the entire route from the first state to the “true” final state provides a valid bit combination representing a character that comports with the formula or regular expression representing valid characters.

Similar to the probability values calculated in operation 212, a probability generated in operation 216 is associated with a given state transition of a BDD. The probability is based on the number of bit combinations for the given state transition and the number of bit combinations for subsequent state transitions leading to the “true” final state. The probability associated with the given state transition is also based on the number of bit combinations of a second state transition that shares an originating state with the given state transition. In addition, the probability associated with the given state transition is also based on the number of bit combinations of the state transitions subsequent to the second state transition.

With reference to the example BDD 500 shown in FIG. 5, example BDD probability equations and calculations are provided for illustrative purposes. In this illustrative example, the example BDD 500 describes an 8-bit binary number from the most significant bit (state labeled as bit 7) to the least significant bit (state labeled as bit 0) with the top most node, node 501, being bit 7. In the description below, a node with a label “k” is the value of the kth bit. As shown in FIG. 5, the transition 550 “skips” the second bit of the 8-bit number, which means that the BDD has exactly the same structure from bit 5=0 as for bit 5=1. Thus, the probability for choosing bit 5=0, or bit 5=1 after bit 6 was chosen to be 1, is 50/50. Stated another way, a probability associated with state transition 550 can be represented by the following equation: “P₂=k₁/k₁+k₂”. The variable k₁ represents the number of bit combinations of state transition 550 and the number of bit combinations of the state transitions subsequent to state transition 550 that lead to the final true state 520. The variable k₂ represents the number of bit combinations of state transition 551 and the number of bit combinations of the state transitions subsequent to state transition 551 that lead to the final true state 520. Similarly, a probability associated with state transition 551 can be represented by the following equation: “P₃=k₂/k₁+k₂”.

As can be appreciated, the probabilities associated with the state transitions of a BDD may be calculated using techniques similar to the techniques described above with respect to the probabilities generated for an SFA. In general, in working backwards from a “true” final state, all bit combinations leading to the state transition associated with the probability are considered. For example, with reference to FIG. 5, in the calculation of a probability associated with state transition 555, the calculation of the probability would involve the number of bit combinations for state transition 555 and the number of bit combinations for two other state transitions 556 and 557. With those calculations, probabilities for upstream state transitions may be calculated.

Once the probabilities for the BDDs and SFAs are generated, these values may be serialized and stored. Storage of the probability data 118, in conjunction with storage of data describing the structure of the associated composed SFAs 117 and BDDs 119, may be stored in any format using any suitable data structure, which for illustrative purposes, is represented in FIG. 1 as output data 114.

Referring again to FIG. 2, the routine 200 proceeds from operation 216 (or from 212 if BDDs are not used) to operation 218 where the walker 112 generates a string or password by traversing the minimized SFA and, if applicable, the associated BDDs. Generally described, the walker 112 accesses the output data 114 to obtain the probability data, the data describing the structure of the minimized SFA and, if applicable, the data describing the structure of the BDDs 119.

To select characters of the string or password, the walker 112 traverses the structure of the SFA from the first state to the last state, and each character is selected at each state transition based on the associated formula defining a set of valid characters. At each state transition, a character may be selected by the use of a number of methods. In one example, the walker 112 may select a character from the formula or associated regular expression at random. In another example, the walker 112 may select a character by traversing through the structure of an associated BDD. It can be appreciated that a character can be selected in a uniformly random fashion using any one or a combination of methods for selecting characters from a BDD, a formula or a regular expression may be used. One technique to select a uniformly random character using a BDD is shown and described below.

In operation 218, when the walker 112 encounters a state having multiple exiting state transitions, the walker 112 selects one of the state transitions based on the associated probabilities. When this scenario is encountered, the process of selecting one exiting state transition over another exiting state transition is based on the probabilities generated in operation 212. For illustrative purposes, with reference to the example SFA 450 of FIG. 4C, the probability associated with state transition 457 is “P₂=0.456” and the probability associated with state transition 454 is “P₃=0.544”.

In this example, as the walker 112 exits state 453, the probability that the walker 112 will select state transition 457 is 0.456. At the same time, the probability that the walker 112 will select state transition 454 is 0.544. Once a particular state transition is selected using the calculated probabilities, the walker 112 utilizes one of a number of methods for selecting a character based on the formula or regular expression associated with the selected state transition. Then, from either state 458 or state 455, depending on which state transition is selected, the walker 112 selects the remaining characters by traversing through the remaining state transitions 459 and 461 or 456 and 461 until the final state is reached.

In embodiments where BDDs are utilized, the walker 112 traverses the structure of a selected BDD to generate a bit combination of a valid character. Generally described, in the process of traversing a BDD, when a single state has more than one exiting state transition, the probability data associated with the BDD is used to select one state transition. With reference to FIGS. 4C and 5, an illustrative example of this process is shown and described below.

As summarized above, the example BDD 500 is used to model the valid characters of several state transitions 452, 456 and 461 of the example SFA 450. In operation 218, when the walker 112 traverses through the example SFA 450 and encounters a state transition associated with the example BDD 500, the walker 112 then traverses the structure of the example BDD 500 to generate a bit combination representing a valid character. Processing of the example BDD 500 starts with state 501 and continues until the final “true” state 520 is reached. As the walker 112 traverses through an individual state transition, the walker 112 records the bit associated with the individual state transition.

When the walker 112 encounters a state having more than one exiting state transition, the walker 112 selects one of the state transitions based on the associated probabilities. For example, at state 502, the walker 112 will select state transition 550 based on the associated probability, P₂, or the walker 112 will select state transition 551 based on the associated probability, P₃.

As can be appreciated, a bit combination is generated as the walker 112 traverses through the each state transition. For example, from state 501 to state 502, the solver records a zero (0) in the first bit position. Next, if state transition 550 is selected, the solver records a one (1) in the second bit position. Once the walker 112 transitions through the example BDD 500 to the final true state 520, the resulting bit combinations produce a binary number representing a character that comports to the regular expression. As can be appreciated, the bit combination may comport to any form of encoding, as the techniques herein may generate arbitrary bit vectors. In one example encoding method, techniques herein may create bit combinations that form ASCII characters. In a specific example, the letter ‘A’ having the binary code of 01000001 can be generated by walking the example BDD 500. Specifically, a node with the label k is the k'th bit, e.g., in ‘A’ bit 7 is 0, bit 6 is 1, bits 5 through 1 are 0, and bit 0 is 1. After bit 6 being assigned the value 1, for the choice of bit 5 being 0, the structure of the BDD is the same as if bit 5 is 1. Thus, the transition 550 corresponds to choosing 2 bits, the first of which is 1 and the second bit is either 0 or 1 with a 50/50 probability.

As also summarized above, embodiments utilizing BDDs may also be used to calculate the probability data associated with the associated SFA. Thus, in such embodiments, the above described process for calculating the probabilities of the example BDD 500 may be used to generate probability data for the associated SFA, which in this example is SFA 450.

By selecting state transitions using the calculated probabilities, in the SFA and optionally, the BDD, it can be appreciated that techniques described herein generate a uniformly random password or string that conforms to the given regular expressions. As can be appreciated, when multiple passwords are generated using the same SFA and the same corresponding BDDs, the associated probability data creates a balance between the different routes in each diagram to mitigate the common problem of biasing a string or password toward certain characters or groups of characters.

As summarized above, techniques for minimizing a SFA are provided herein. With reference to FIGS. 6 and 7A-7E, the following section describes a routine 600 for minimizing an example SFA 700. In summary, the routine 600 utilizes over-approximation techniques to minimize the example SFA 700. As described in more detail below, the techniques for minimizing the SFA include a selection of a set of states for various partitions. The partitions are refined based on predicates of the states selected for individual partitions. Once the partitions are created, the states of individual partitions are unionized to formulate states and state transitions of a minimized SFA.

Referring now to FIG. 6, a flow diagram showing aspects of one illustrative routine 600 for minimizing a SFA is shown and described. The following description also refers to the example SFA 700 of FIGS. 7A-7D. In brief, the illustrative routine 600 examines the example SFA 700 and selects particular groupings of states for individual partitions, and based on an over-approximation technique, the example SFA 700 is processed to the minimized SFA 727 of FIG. 7E.

The routine 600 begins at operation 601, where the solver 110 selects states for an initial partition. In one embodiment of operation 601, the solver 110 divides the states of the example SFA 700 into two categories: final states and non-final states. The solver 110 then selects one of the two categories of states for the initial partition. In general, either category of the states can be selected for the initial partition. In one embodiment, the solver 110 selects the category with the fewest states to be included in the initial partition.

In applying the example SFA 700 of FIG. 7A to operation 601, since the q₅ state 707 is the only final state, the solver 110 places the q₅ state 707 in a first category, and all other non-final states 701-705 in a second category. In applying one embodiment of the operation 601, the embodiment where the category having the fewest states is selected for the initial partition, since the first category has only one state, the q₅ state 707, and the second category has five states, states 701-705, the q₅ state 707 is selected for the initial partition. For illustrative purposes, FIG. 7B shows a pictorial representation of the initial partition, referred to herein as “the first partition 784,” which is defined by the first partition boundary 770. As applied in the current example, the q₅ state 707 is included in the initial partition.

Next, at operation 603, the solver 110 selects a second set of states to be included in a subsequent partition. Generally described, operation 603 includes the selection of one or more states that have state transitions leading into the states of the initial partition. Thus, in applying operation 603 to the example SFA 700, the q₂ state 704 and the q₄ state 705 both have state transitions 725 and 726 leading into the state (q₅ state 707) included in the initial partition. Thus, q₂ state 704 and the q₄ state 705 are both selected for the subsequent partition, which in this example is referred to as the “second partition 783.” For illustrative purposes, the second partition boundary 771 is shown in FIG. 7C, which shows the boundary for the second partition 783.

Next, at operation 605, the solver 110 refines the subsequent partition. Generally described, in operation 605, the subsequent partition may be split to create additional partitions if the states included in the subsequent partition do not have equivalent predicates. As can be appreciated, generally known techniques for determining the existence of equivalent predicates may be used in operation 605. For illustrative purposes, FIG. 7C provides an example of how operation 605 may be applied to the example SFA 700. As shown, the q₂ state 704 and the q₄ state 705 are both included in the second subsequent partition, the second partition 783. As also shown, the q₂ state 704 and the q₄ state 705 both have state transitions leading to the q₅ state 707, where each state has the same value of φ₃. Given these conditions, and given that the q₂ state 704 and the q₄ state 705 both have state transitions leading to states in the same partition, the solver 110 would determine that the predicates of the states included in the subsequent partition are equivalent, and the subsequent partition would not be split.

To illustrate the concepts of the refining process of operation 605, another example is provided herein to show how the subsequent partition, e.g., the second partition 783, would be split. In such a scenario, the second partition would be split if states of the subsequent partition have predicates that are not equivalent. For example, if the state transition 726 had the value of φ₃ instead of φ₃, the q₂ state 704 and the q₄ state 705 would not have equivalent predicates. Thus, given this scenario, the solver 110 would create a refining partition boundary 773 to split the second partition 783 into two different partitions. As described in more detail below, a split of the second partition impacts the outcome of the minimized SFA.

Returning to FIG. 6, next, at operation 607 the solver 110 determines if there are additional states in the SFA to process. In one embodiment, the solver 110 determines if additional states exist by searching for states that lead into the states of the current partition. In one embodiment of operation 607, the solver 110 examines the SFA and determines if there are any states that lead into the states included in the partition processed in the previous iteration of operation 605. If any preceding states exist, the routine 600 returns to operation 603 where the solver 110 selects states of another subsequent partition.

An illustration of operation 607 is shown in FIG. 7C, where the q₂ state 704 and the q₄ state 705 are included in the second partition 783, e.g., the current partition. As shown, in the examination of the states of the current partition, the solver 110 would determine that the SFA has states that lead into the states of the current partition: the q₁ state 702 and the q₃ state 703. As applied to the example SFA 700, given the existence of these preceding states, operation 607 would determine that there are additional states to examine. Thus, the routine 600 would return to operation 603 for a second iteration of operation 603. In the second iteration of operation 603, the solver 110 would select the q₁ state 702 and the q₃ state 703 for the next subsequent partition because the q₁ state 702 and the q₃ state 703 both lead to the states of the second partition 783. With reference to FIG. 7D, the second pass of operation 603 would create the third partition 782, which is defined by the partition third partition boundary 772 and the second partition boundary 771.

Next, in applying the example SFA 700 to the second iteration of operation 603, once states are selected for the subsequent partition, the routine 600 proceeds to operation 605 where the solver 110 refines the new subsequent partition. In applying the example SFA 700 to the second iteration of operation 605, the solver 110 examines the states of the third partition 782 to determine if they have equivalent predicates. Given that the state transitions exiting the q₁ state 702 and the q₃ state 703 have the same value, φ₂, and that they both have exiting transitions leading to states in the same partition, the second partition 783, the solver 110 would determine that the states of the third partition 782 are equivalent, and thus, the third partition 782 would not be split into multiple partitions.

In further processing of the example SFA 700, routine 600 continues processing until the q₀ state 701 is processed in the manner described above, after which, at operation 607, the solver 110 would determine that there are no additional states to examine. The routine 600 then proceeds to operation 609 where the solver 110 unionizes the states of the individual partitions. As can be appreciated, a number of known methods for unionizing, also referred to as “normalizing,” states and state transitions can be applied to execute operation 609. Generally described, the states of each partition are analyzed and individual states and state transitions of each partition are collapsed and merged.

FIG. 7E illustrates one example of a resulting SFA 727 from operation 609. As shown, the states and state transitions of the second partition 783 are collapsed and merged to form the (2,4) state 712, which has an exiting state transition with a value of φ₃. This result is from the union of the state transitions 725 and 726 of FIG. 7D. In addition, the (1,3) state 711 has an exiting state transition with a value of φ₂, which is from the union of the state transitions 723 and 724. In addition, the (0) state 710 has an exiting state transition with the value of TRUE, which is from the union of the state transitions 721 and 722. As shown in FIG. 7E, the resulting SFA 727 is minimized. The resulting SFA 727 comprises only four (4) states 710-713 and three resulting state transitions 728-730.

FIG. 7E also shows an additional state 776 which would result in the above-described example with a different value, ψ₃, at the state transition 726 exiting the q₄ state 705. As summarized above, this example was provided to show how operation 605 processes two states of the same partition that have non-equivalent predicates. When this example scenario is applied to the example SFA 700, as shown in FIG. 7D, the second partition is split with refining partition boundary 773. The refining partition boundary 773 illustrates that the q₂ state 704 and the q₄ state 705 are split into separate partitions since, in this example, they do not have equivalent predicates. In the unionizing process of operation 609 of this example, the resulting SFA 727 would also include the additional state 776, which also includes an exiting state transition having a value of ψ₃.

For illustrative purposes, example program code (“code”) for performing a minimization process is provided below. To illustrate this embodiment of the minimization process, the description following the example code set forth in Table 2 also refers to the example SFA 700 of FIGS. 7A-7D.

TABLE 2

| | |
|---|---|
| Line 1: | Min_{SFA}^{N} (M = ( [symbol] , Q, q⁰, F, Δ)) [symbol] |
| Line 2: | [symbol] := {F, Q \ F}; //initial partition |
| Line 3: | W := {if (\|F\| ≦ \|Q / F\|) then F else Q \ F}; |
| Line 4: | while (W ≠ ) //main loop |
| Line 5: | [symbol] := choose (W); W := W \ { [symbol] }; |
| Line 6: | S := δ⁻¹(T, [symbol] ); //all states leading into [symbol] |
| Line 7: | $Γ := \{ p ↦ {}_{( p , ϕ , - ) ∈ {←}_{Δ} ( R )} ϕ \} p ∈ s ; // maps p to the pred . into ℛ$ |
| Line 8: | while (exists (P in [symbol] ) where P ∩ S ≠ and P \ S ≠ ) |
| Line 9: | [symbol] [symbol] , W [symbol] := Split_{p,w}(P, P ∩ S, P \ S); //(_, [symbol] )-split |
| Line 10: | while (exists (P in [symbol] ) where P ∩ S ≠ and |
| Line 11: | (exists (p1, p2 in P) where IsSat ( [symbol] (Γ(p1)) [symbol] Γ(p2)))) |
| Line 12: | a := choose ( [symbol] [symbol] (Γ(p1) [symbol] Γ(p2)) [symbol] ); |
| Line 13: | P₁ := {p ε P\|a ε [symbol] Γ(p) [symbol] }; |
| Line 14: | [symbol] [symbol] , W [symbol] := [symbol] (P, P₁, P \ P₁); //(a, [symbol] )-split |
| Line 15: | return [symbol] ; |

As described above and represented in operation 601 of FIG. 6, the solver 110 determines an initial partition. This step is represented in Line 2 of the sample code, where the solver 110 divides the states of the example SFA 700 into two categories: a first category having final states and a second category having non-final states. The calligraphic [symbol] represents a partitioning that separates the final states (F) from the non-final states (Q\F). In addition, as shown in Line 3, if the first category of states has fewer or an equal number of states, the first category of states is selected for a work item, where W represents the current work item. As mentioned above, embodiments provided herein do not require the selection of the category having fewer states, as this embodiment is only one way of implementing the minimization techniques.

With reference to the example SFA 700 of FIG. 7A, since the q₅ state 707 is a final state, the solver 110 places the q₅ state 707 in one category, and all other non-final states 701-705 in another category. With reference to the sample code, the second category of states 701-705 associated with the non-final set “(Q\F)” and the first category of states, which includes the q₅ state 707, are associated with the final set (F). For illustrative purposes FIG. 7B illustrates a pictorial representation of the first partition 784, which is symbolized as, “={F, Q\F}”. In applying the example of FIG. 7A, given there are fewer final states than non-final states, the final state, q₅ state 707, is included in the first partition 784.

The above-described are symbolized in the sample code shown in Table 2 in a manner that allows the solver 110 to maintain a list of work items. The vertical bars on each side of the variable indicate that the condition is based on a count of states. Thus, in accordance with the code of Line 3, the current work item is the final set (F) if the number of final states “|F|” is less than or equal to the number of non-final states “|Q\F|”. However, if the number of final states “|F|” is not less than or equal to the number of non-final states “|Q\F|”, then the current work item is the non-final set (Q\F). In applying the above-described example to the sample code, since the final set (F) contains only one state, e.g., the q₅ state 707, and the non-final set (Q\F) contains five states, e.g., states 701-705, the current work item includes the final state, which can be symbolized as “W:=F”. Since the work item is not equal to a null value, the “while” loop continues processing the work item.

Line 5 of the sample code shown in Table 2 illustrates how the list of work items can be maintained. As shown in the sample code, the variable, R, is assigned the value of the current work item, and the current work item variable, W, is reset for the next iteration of the loop. As applied to the example SFA 700, in this iteration of the process, [symbol] is equal to the final set (F), which includes the q₅ state 707.

Next, at Line 6 of the sample code shown in Table 2, the solver 110 identifies the states that lead into the state or states being processed, e.g., an identification of all states leading into [symbol] . An example implementation of this operation is shown, where the S variable is equal to all of the states leading into R. This implementation describes, in part the operation 603 of FIG. 6, where states are selected based on the leading state transition. In applying the example SFA 700 to this example, S is equal to the q₂ state 704 and the q₄ state 705 since they both lead into the final state.

Next, Line 7 of the code in Table 2, the solver 110 maps the value of each transition leading into the state or states being processed, e.g., a map of all values leading into [symbol] . In this example, Gamma, F, includes map of the transition values of S. More specifically, the symbolic representations of Line 8 show that Gamma is a map of every element in S, which is also referred to as a union of all the predicates that lead into [symbol] . In applying the example SFA 700 to operation 607, given the value of [symbol] , which includes the 5th state 707, and the value of S, which includes the q₂ state 704 and the q₄ state 705, Gamma, Γ, is {q₂ [symbol] φ₃, q₄ [symbol] φ₃}.

Next, at Lines 8 and 9, the sample code shown in Table 2 determines if the predicates of the q₂ state 704 and the q₄ state 705 are equivalent, if they are not equivalent, a split of the partition is performed. As described above, as applied to the example SFA 700, since the predicates of the q₂ state 704 and the q₄ state 705 are equivalent, the partition is not split. The second “while” command at Line 10 also represents a second test to determine if states referenced in the work item have equivalent predicates. As with the processing of Lines 8 and 9, at Lines 10-14, if it is determined that the states referenced in the work item do not have equivalent predicates, the partition is split to separate the states that do not have equivalent predicates. The sample code shown in Table 2 is configured to cycle through the states of the SFA until there are no more states to process in the work item. With each cycle of the code, the partitions 781-784 shown in FIG. 7D are generated.

Once the partitions are determined, the normalization process, e.g., the unionization of the states sharing individual partitions is performed. As described above, known methods for unionizing or normalizing groups of particular states can be used to implement this part of the process. As described above, the resulting minimized SFA 727 comprises only four (4) states 710-713 and three resulting state transitions 728-730. The state transition 728 has a value of TRUE value. The state transition 729 is has a value of φ₂ and the state transition 730 has a value of φ₃.

For illustrative purposes, another example coded algorithm is provided in Table 3 for performing the minimization process. Aspects of the code shown below in Table 3 illustrate features, and other aspects, of the above-described embodiments.

TABLE 3

```
MinSFA (Automaton)
{
  var fB = new Block(fa.GetFinalStates( ));
  var nfB = new Block(fa.GetNonFinalStates( ));
  var blocks = new Dictionary<int, Block>( );
  foreach (var q in fa.GetFinalStates( )) blocks[q] = fB;
  foreach (var q in fa.GetNonFinalStates( )) blocks[q] = nfB;
  var W = new BlockStack( );
  if (nfB.Count < fB.Count) W.Push(nfB); else W.Push(fB);
  while (!W.IsEmpty) {
    var R = W.Pop( );
    var G = ...
    var S = G.Keys;
    var relevant = ...
    foreach (var P in relevant){
      var P1 = ...
      if (P1.Count < P.Count) {
        foreach (var p in P1) { P.Remove(p); blocks[p] = P1;}
        if (W.Contains(P)) W.Push(P1);
        else if (P.Count <= P1.Count) W.Push(P);
        else W.Push(P1);
  }}
  bool iterate = true;
  while (iterate) {
      iterate = false;
      relevant = ...
      foreach (var P in relevant) {
        var P1 = new Block( );
        var psi = G[P.Current];
        bool splitterFound = false;
        P1.Add(P.Current);
        while (P.MoveNext( )) {
            var q = P.Current;
            var phi = G[q];
            if (splitterFound) {
              if (IsSat(psi & phi)) { P1.Add(q); psi = psi & phi;}
            } else {
              if (IsSat(psi & !phi)) {
                psi = psi & !phi;
                splitterFound = true;
              } else {
                if (IsSat(phi & !psi)) {
                  P1.Clear( ); P1.Add(q);
                  psi = phi & !psi;
                  splitterFound = true;
                } else P1.Add(q);
        }}}
        if (P1.Count < P.Count) {
          iterate = (iterate || (P.Count > 2));
          foreach (var p in P1) { P.Remove(p); blocks[p] = P1; }
          if (W.Contains(P)) W.Push(P1);
          else if (P.Count <= P1.Count) W.Push(P);
          else W.Push(P1);
  }}}}}
```

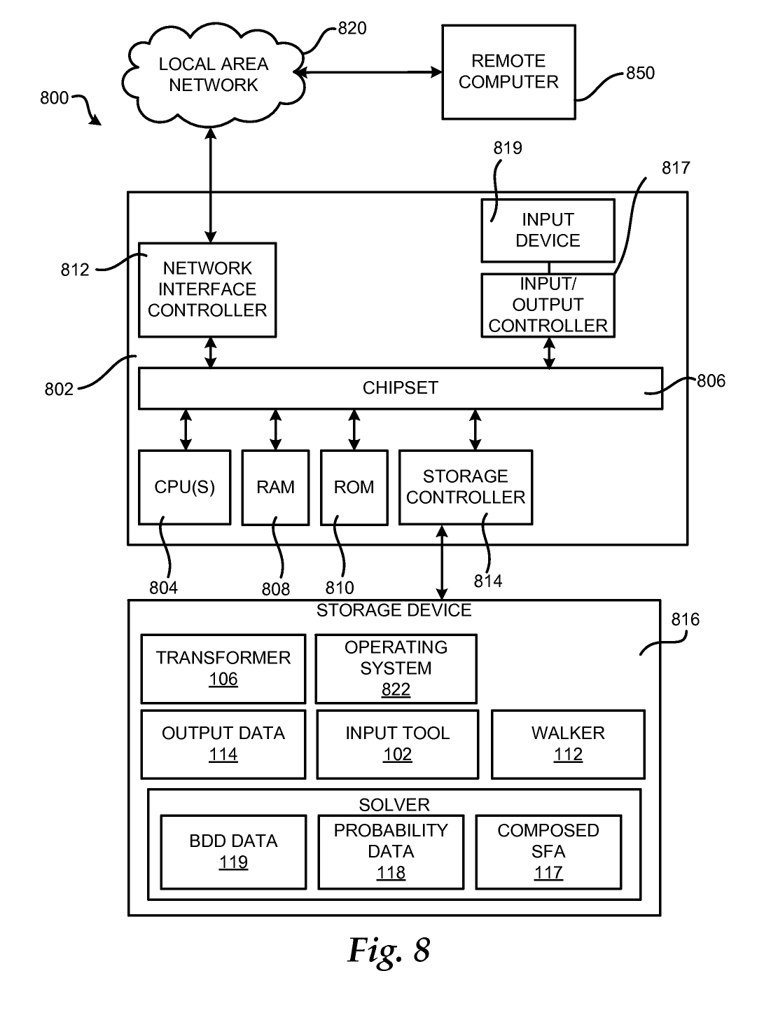

FIG. 8 shows an example computer architecture for a computing device 800 capable of storing and executing the components shown in FIG. 1. The computer architecture shown in FIG. 8 illustrates a conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 8 may be utilized to execute any of the software components described above.

The computing device 800 includes a baseboard 802, or “motherboard,” which is a printed circuit board to which a multitude of components or devices may be connected by way of a system bus or other electrical communication paths. In one illustrative embodiment, one or more central processing units (“CPUs”) 804 operate in conjunction with a chipset 806. The CPUs 804 may be standard programmable processors that perform arithmetic and logical operations necessary for the operation of the computing device 800.

The CPUs 804 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 may provide an interface to a RAM 808, used as the main memory in the computing device 800. The chipset 806 may further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM may also store other software components necessary for the operation of the computing device 800 in accordance with the embodiments described herein.

The computing device 800 may operate in a networked environment using logical connections to remote computing devices and computer systems through a network, such as the local area network 820. The chipset 806 may include functionality for providing network connectivity through a network interface controller (NIC) 812, such as a gigabit Ethernet adapter. The NIC 812 is capable of connecting the computing device 800 to other computing devices over the network 820. It should be appreciated that multiple NICs 812 may be present in the computing device 800, connecting the computer to other types of networks and remote computer systems. The local area network 820 allows the computing device 800 to communicate with remote services and servers, such as a remote computer 850.

The computing device 800 may be connected to a mass storage device 816 that provides non-volatile storage for the computing device. The mass storage device 816 may store system programs, application programs, other program modules, and data, which have been described in greater detail herein. The mass storage device 816 may be connected to the computing device 800 through a storage controller 814 connected to the chipset 806. The mass storage device 816 may consist of one or more physical storage units. The storage controller 814 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 816, other storage media and the storage controller 814 may include MultiMediaCard (MMC) components, eMMC components, Secure Digital (SD) components, PCI Express components, or the like.

The computing device 800 may store data on the mass storage device 816 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 816 is characterized as primary or secondary storage, and the like.

For example, the computing device 800 may store information to the mass storage device 816 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 816 by detecting the physical states or characteristics of one or more particular locations within the physical storage units.

In addition to the mass storage device 816 described above, the computing device 800 may have access to other computer-readable storage media to store and retrieve information, such as program modules, data structures, or other data. Thus, although the input tool 102, transformer 106, solver 110, walker 112 and other modules are depicted as data and software stored in the mass storage device 816, it should be appreciated that the input tool 102, transformer 106, solver 110, walker 112 and/or other modules may be stored, at least in part, in other computer-readable storage media of the device 800. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computing device 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 800. For purposes of the claims, the phrase “computer storage medium,” “computer-readable storage medium,” and variations thereof, does not include waves or signals per se and/or communication media.

The mass storage device 816 may store an operating system 822 utilized to control the operation of the computing device 800. According to one embodiment, the operating system comprises the LINUX operating system. According to another embodiment, the operating system comprises the WINDOWS® operating system from MICROSOFT Corporation. According to further embodiments, the operating system may comprise the UNIX, Android, Windows Phone or iOS operating systems. It should be appreciated that other operating systems may also be utilized. The mass storage device 816 may store other system or application programs and data utilized by the computing device 800, such as the regular expressions 104, SFA data 108, output data 114, the password or string data 116 and/or any of the other software components and data described above. The mass storage device 816 might also store other programs and data not specifically identified herein.

In one embodiment, the mass storage device 816 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs 804 transition between states, as described above. According to one embodiment, the computing device 800 has access to computer-readable storage media storing computer-executable instructions which, when executed by the computing device 800, perform the various routines described above with regard to FIGS. 2 and 6. The computing device 800 might also include computer-readable storage media for performing any of the other computer-implemented operations described herein.

The computing device 800 may also include one or more input/output controllers 817 for receiving and processing input from an input device 819. The input device 819 may include a number of input devices, such as a keyboard, a mouse, a microphone, a headset, a touchpad, a touch screen, an electronic stylus, or any other type of input device. Similarly, the input/output controller 817 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

The disclosure presented herein may be considered in view of the following clauses:

Clause 1: In a computing environment, a method performed at least in part by a processor, comprising: generating a symbolic finite automaton from a regular expression; associating a state transition of the symbolic finite automaton with a formula defining valid characters; calculating a probability associated with the state transition of the symbolic finite automaton, wherein the probability is based, at least in part, on a number of valid characters defined in the formula; and generating a string that conforms to the regular expression by traversing the symbolic finite automaton, selecting the state transition based on, at least in part, the probability associated with the state transition, and selecting a character based on the formula defining valid characters.

Clause 2: The method of clause 1, wherein the probability is based on the number of valid characters associated with the state transition divided by a sum of the number of valid characters associated with the state transition, a number of valid characters associated with state transitions succeeding the state transition, a number of valid characters associated a second state transition that shares a common state with the state transition, and a number of valid characters associated with state transitions succeeding the state second transition.

Clause 3: The method of clauses 1-2, wherein the probability is based on a binary decision diagram modeling the formula defining valid characters.

Clause 4: The method of clauses 1-3, further comprising calculating a second probability for a second state transition, wherein the state transition and the second state transition both transition from a common state, and wherein selecting a character comprises selecting the state transition or the second state transition based on the probability or the second probability, selecting the character from the valid characters associated with the state transition if the state transition is selected, and selecting a character from at least one valid character associated with the second state transition if the second state transition is selected.

Clause 5: The method of clauses 1-4, wherein the symbolic finite automaton includes a plurality of states, the plurality of states include at least one final state and at least one non-final state, and wherein the method further comprises: selecting at least one state of the plurality of states to be included in an initial partition, wherein the initial partition includes the at least one final state or the at least one non-final state; selecting a second set of states of the plurality of states to be included in a second partition, wherein individual states of the second set of states have transitions that lead to the at least one state included in the initial partition; if a predicate of at least one individual state of the second set of states is not equivalent to a predicate of another individual state of the second set of states, refining the second partition to create a third partition, selecting the at least one individual state of the second set of states to be included in the third partition; and unionizing the states included in the individual partitions to minimize the symbolic finite automaton.

Clause 6: The method of clauses 1-5, further comprising determinizing the symbolic finite automaton.

Clause 7: The method of clauses 1-6, further comprising, determining if a number of final states is equal to or fewer than a number of non-final states, and wherein the initial partition includes the at least one final state if the number of final states is equal to or fewer than the number of non-final states.

Clause 8: The method of clauses 1-7, further comprising generating a binary decision diagram for the state transition of the symbolic finite automaton, wherein the binary decision diagram models the formula defining valid characters, and wherein selecting the character is also based, at least in part, on the binary decision diagram.

Clause 9: A computer-readable storage medium having computer-executable instructions stored thereupon which, when executed by a computing device, cause the computing device to: obtain a regular expression defining one or more constraints for a password; generate a symbolic finite automaton representing the regular expression; generate a minimized symbolic finite automaton by minimizing the symbolic finite automaton, wherein the minimized symbolic finite automaton comprises a state transition associated with a formula identifying at least one valid character; generate a probability for the state transition of the minimized symbolic finite automaton, wherein the probability is based on the formula identifying at least one valid character; and traverse the minimized symbolic finite automaton and selecting the state transition based on the probability, and selecting a character of the password based on the formula identifying at least one valid character.

Clause 10: The computer-readable storage medium of clause 9, wherein the symbolic finite automaton includes a plurality of states, and wherein minimizing the symbolic finite automaton comprises: selecting at least one state of the plurality of states to be included in a first partition; selecting a second set of states of the plurality of states to be included in a second partition, wherein individual states of the second set of states have transitions that lead to the at least one state included in the first partition; if a predicate of at least one individual state of the second set of states is not equivalent to a predicate of another individual state of the second set of states, refining the second partition to create a third partition, selecting the at least one individual state of the second set of states to be included in the third partition; and unionizing the states included in the first partition, the second partition and the third partition, wherein the unionized states are combined to create the minimized symbolic finite automaton.

Clause 11: The computer-readable storage medium of clauses 9-10, wherein the plurality of states include at least one final state and at least one non-final state, wherein the computer-executable instructions further cause the computing device to determine if a number of final states is equal to or fewer than a number of non-final states, and wherein the first partition includes the at least one final state if the number of final states is equal to or fewer than the number of non-final states.

Clause 12: The computer-readable storage medium of clauses 9-11, wherein the probability is based on a count of valid characters associated with the state transition divided by a sum of the count of valid characters associated with the state transition, a count of valid characters associated with state transitions succeeding the state transition, a count of valid characters associated a second state transition that shares a common state with the state transition, and a count of valid characters associated with state transitions succeeding the state second transition.

Clause 13: The computer-readable storage medium of clauses 9-12, wherein the computer-executable instructions further cause the computing device to determinize the symbolic finite automaton.

Clause 14: The computer-readable storage medium of clauses 9-13, wherein the computer-executable instructions further cause the computing device to generate a binary decision diagram for the state transition of the symbolic finite automaton, wherein the binary decision diagram models the formula identifying at least one valid character, and wherein selecting the character is also based, at least in part, on the binary decision diagram.

Clause 15: The computer-readable storage medium of clauses 9-14, wherein the probability is based on a binary decision diagram modeling the formula identifying at least one valid character.

Clause 16: A computing device, comprising: a processor; and a computer-readable storage medium in communication with the processor, the computer-readable storage medium having computer-executable instructions stored thereupon which, when executed by the processor, cause the processor to obtain a plurality of regular expressions defining constraints for a password, generate a plurality of symbolic finite automata, wherein an individual symbolic finite automaton of the plurality of symbolic finite automaton represents an individual regular expression of the plurality of regular expressions, generate a composed symbolic finite automaton based on the plurality of symbolic finite automata, determinize the composed symbolic finite automaton or determinize the plurality of symbolic finite automata prior to generating the composed symbolic finite automaton, minimize the composed symbolic finite automaton, wherein the composed symbolic finite automaton comprises a state transition associated with a formula representing valid characters, generate a binary decision diagram modeling the formula representing valid characters, generate a probability associated with a state transition of the binary decision diagram, wherein the probability for the state transition of the binary decision diagram is based, at least in part, on a number of valid bit combinations associated with the formula representing valid characters, generate a probability associated with the state transition of the minimized composed symbolic finite automaton, wherein the probability is based on, at least in part, on the binary decision diagram modeling the formula representing valid characters, and determine an individual character of the password by selecting an individual state transition of the composed symbolic finite automaton based on the probability associated with the state transition of the composed symbolic finite automaton, and selecting a bit combination representing the individual character based on the probability associated with the state transition of the binary decision diagram.

Clause 17. The computing device of clause 16, wherein the probability associated with the state transition of the minimized composed symbolic finite automaton is based on a count of valid characters associated with the state transition divided by a sum of the count of valid characters associated with the state transition, a count of valid characters associated with state transitions succeeding the state transition, a count of valid characters associated a second state transition that shares a common state with the state transition, and a count of valid characters associated with state transitions succeeding the state second transition.

Clause 18: The computing device of clauses 16-17, wherein the composed symbolic finite automaton includes a plurality of states, wherein the plurality of states includes at least one final state and at least one non-final state, and wherein minimizing the composed symbolic finite automaton comprises: selecting at least one state of the plurality of states to be included in an initial partition, wherein the initial partition includes the at least one final state or the at least one non-final state; selecting a second set of states of the plurality of states to be included in a second partition, wherein individual states of the second set of states have transitions that lead to the at least one state included in the initial partition; if a predicate of at least one individual state of the second set of states is not equivalent to a predicate of another individual state of the second set of states, refining the second partition to create a third partition, selecting the at least one individual state of the second set of states to be included in the third partition; and unionizing the states included in the initial partition, the second partition and the third partition, wherein the unionized states are combined to minimize the symbolic finite automaton.

Clause 19: The computing device of clauses 16-18, wherein selecting the at least one state of the plurality of states to be included in an initial partition comprises: determining if a number of final states is equal to or fewer than a number of non-final states, and selecting the at least one final state to be included in the initial partition if the number of final states is equal to or fewer than the number of non-final states.

Clause 20: The computing device of 16-19, wherein the binary decision diagram comprises a first state and a final state, and wherein selecting a bit combination representing the individual character comprises: traversing the binary decision diagram from the first state to the final state to generate the bit combination representing the individual character; and selecting the state transition of the binary decision diagram based on the probability associated with the state transition of the binary decision diagram.

Clause 21: In a computing environment, a method performed at least in part by a processor, comprising: obtaining a symbolic finite automaton from a regular expression; associating a state transition of the symbolic finite automaton with a formula defining valid characters; and traversing the symbolic finite automaton by selecting state transitions and characters based on the formulas defining valid characters for those transitions.

Clause 22: the method of clause 21, wherein obtaining the symbolic finite automaton includes receiving the symbolic finite automaton from a remote computer.

Clause 23: the method of clause 21, wherein obtaining the symbolic finite automaton includes generating the symbolic finite automaton from data defining regular expressions.

Based on the foregoing, it should be appreciated that concepts and technologies for generating strings or passwords from regular expression are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims. In addition, it can be appreciated that other variations of the techniques described herein are also within the scope of the current disclosure. For instance, it can be appreciated that operations of FIG. 2 may be in a different order or, when possible, certain operations are processed in parallel. In addition, certain operations may apply to other types of data and structures other than those specifically described herein. For instance, the operation for traversing through an SFA to select characters of a password may involve an SFA that is not minimized. In addition, although the state transitions are described with a particular sequence or path, it can be appreciated that the sequence or path is used for illustrative purposes only. The sequence or path of the example walking processes do not signify that the transitions follow the examples described herein. In addition, it can be appreciated that a subset of the operations disclosed herein may be used to implement aspects of the described technologies. For instance, techniques for generating a password or string may only include routines for reading and processing serialized data to traverse a composed SFA.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. In a computing environment, a method performed at least in part by a processor, comprising:
generating a symbolic finite automaton from a regular expression;
associating a state transition of the symbolic finite automaton with a formula defining valid characters;
calculating a probability associated with the state transition of the symbolic finite automaton, wherein the probability is based, at least in part, on a number of valid characters defined in the formula; and
generating a string that conforms to the regular expression by
traversing the symbolic finite automaton,
selecting the state transition based on, at least in part, the probability associated with the state transition, and
selecting a character based on the formula defining valid characters.

2. The method of claim 1, wherein the probability is based on the number of valid characters associated with the state transition divided by a sum of the number of valid characters associated with the state transition, a number of valid characters associated with state transitions succeeding the state transition, a number of valid characters associated a second state transition that shares a common state with the state transition, and a number of valid characters associated with state transitions succeeding the state second transition.

3. The method of claim 1, wherein the probability is based on a binary decision diagram modeling the formula defining valid characters.

4. The method of claim 1, further comprising calculating a second probability for a second state transition, wherein the state transition and the second state transition both transition from a common state, and wherein selecting a character comprises
selecting the state transition or the second state transition based on the probability or the second probability,
selecting the character from the valid characters associated with the state transition if the state transition is selected, and
selecting a character from at least one valid character associated with the second state transition if the second state transition is selected.

5. The method of claim 1, wherein the symbolic finite automaton includes a plurality of states, the plurality of states include at least one final state and at least one non-final state, and wherein the method further comprises:
selecting at least one state of the plurality of states to be included in an initial partition, wherein the initial partition includes the at least one final state or the at least one non-final state;
selecting a second set of states of the plurality of states to be included in a second partition, wherein individual states of the second set of states have transitions that lead to the at least one state included in the initial partition;
if a predicate of at least one individual state of the second set of states is not equivalent to a predicate of another individual state of the second set of states,
refining the second partition to create a third partition,
selecting the at least one individual state of the second set of states to be included in the third partition; and
unionizing the states included in the individual partitions to minimize the symbolic finite automaton.

6. The method of claim 1, further comprising determinizing the symbolic finite automaton.

7. The method of claim 5, further comprising, determining if a number of final states is equal to or fewer than a number of non-final states, and wherein the initial partition includes the at least one final state if the number of final states is equal to or fewer than the number of non-final states.

8. The method of claim 1, further comprising generating a binary decision diagram for the state transition of the symbolic finite automaton, wherein the binary decision diagram models the formula defining valid characters, and wherein selecting the character is also based, at least in part, on the binary decision diagram.

9. A computer-readable storage medium having computer-executable instructions stored thereupon which, when executed by a computing device, cause the computing device to:
obtain a regular expression defining one or more constraints for a password;
generate a symbolic finite automaton representing the regular expression;
generate a minimized symbolic finite automaton by minimizing the symbolic finite automaton, wherein the minimized symbolic finite automaton comprises a state transition associated with a formula identifying at least one valid character;
generate a probability for the state transition of the minimized symbolic finite automaton, wherein the probability is based on the formula identifying at least one valid character; and
traverse the minimized symbolic finite automaton and selecting the state transition based on the probability, and selecting a character of the password based on the formula identifying at least one valid character.

10. The computer-readable storage medium of claim 9, wherein the symbolic finite automaton includes a plurality of states, and wherein minimizing the symbolic finite automaton comprises:
selecting at least one state of the plurality of states to be included in a first partition;
selecting a second set of states of the plurality of states to be included in a second partition, wherein individual states of the second set of states have transitions that lead to the at least one state included in the first partition;
if a predicate of at least one individual state of the second set of states is not equivalent to a predicate of another individual state of the second set of states,
refining the second partition to create a third partition,
selecting the at least one individual state of the second set of states to be included in the third partition; and
unionizing the states included in the first partition, the second partition and the third partition, wherein the unionized states are combined to create the minimized symbolic finite automaton.

11. The computer-readable storage medium of claim 9, wherein the plurality of states include at least one final state and at least one non-final state, wherein the computer-executable instructions further cause the computing device to determine if a number of final states is equal to or fewer than a number of non-final states, and wherein the first partition includes the at least one final state if the number of final states is equal to or fewer than the number of non-final states.

12. The computer-readable storage medium of claim 9, wherein the probability is based on a count of valid characters associated with the state transition divided by a sum of the count of valid characters associated with the state transition, a count of valid characters associated with state transitions succeeding the state transition, a count of valid characters associated a second state transition that shares a common state with the state transition, and a count of valid characters associated with state transitions succeeding the state second transition.

13. The computer-readable storage medium of claim 9, wherein the computer-executable instructions further cause the computing device to determinize the symbolic finite automaton.

14. The computer-readable storage medium of claim 9, wherein the computer-executable instructions further cause the computing device to generate a binary decision diagram for the state transition of the symbolic finite automaton, wherein the binary decision diagram models the formula identifying at least one valid character, and wherein selecting the character is also based, at least in part, on the binary decision diagram.

15. The computer-readable storage medium of claim 9, wherein the probability is based on a binary decision diagram modeling the formula identifying at least one valid character.

16. A computing device, comprising:
a processor; and
a computer-readable storage medium in communication with the processor, the computer-readable storage medium having computer-executable instructions stored thereupon which, when executed by the processor, cause the processor to
obtain a plurality of regular expressions defining constraints for a password,
generate a plurality of symbolic finite automata, wherein an individual symbolic finite automaton of the plurality of symbolic finite automaton represents an individual regular expression of the plurality of regular expressions,
generate a composed symbolic finite automaton based on the plurality of symbolic finite automata,
determinize the composed symbolic finite automaton or determinize the plurality of symbolic finite automata prior to generating the composed symbolic finite automaton,
minimize the composed symbolic finite automaton, wherein the composed symbolic finite automaton comprises a state transition associated with a formula representing valid characters,
generate a binary decision diagram modeling the formula representing valid characters,
generate a probability associated with a state transition of the binary decision diagram, wherein the probability for the state transition of the binary decision diagram is based, at least in part, on a number of valid bit combinations associated with the formula representing valid characters,
generate a probability associated with the state transition of the minimized composed symbolic finite automaton, wherein the probability is based on, at least in part, on the binary decision diagram modeling the formula representing valid characters, and
determine an individual character of the password by
selecting an individual state transition of the composed symbolic finite automaton based on the probability associated with the state transition of the composed symbolic finite automaton, and
selecting a bit combination representing the individual character based on the probability associated with the state transition of the binary decision diagram.

17. The computing device of claim 16, wherein the probability associated with the state transition of the minimized composed symbolic finite automaton is based on a count of valid characters associated with the state transition divided by a sum of the count of valid characters associated with the state transition, a count of valid characters associated with state transitions succeeding the state transition, a count of valid characters associated a second state transition that shares a common state with the state transition, and a count of valid characters associated with state transitions succeeding the state second transition.

18. The computing device of claim 16, wherein the composed symbolic finite automaton includes a plurality of states, wherein the plurality of states includes at least one final state and at least one non-final state, and wherein minimizing the composed symbolic finite automaton comprises:
selecting at least one state of the plurality of states to be included in an initial partition, wherein the initial partition includes the at least one final state or the at least one non-final state;
selecting a second set of states of the plurality of states to be included in a second partition, wherein individual states of the second set of states have transitions that lead to the at least one state included in the initial partition;
if a predicate of at least one individual state of the second set of states is not equivalent to a predicate of another individual state of the second set of states,
refining the second partition to create a third partition,
selecting the at least one individual state of the second set of states to be included in the third partition; and
unionizing the states included in the initial partition, the second partition and the third partition, wherein the unionized states are combined to minimize the symbolic finite automaton.

19. The computing device of claim 18, wherein selecting the at least one state of the plurality of states to be included in an initial partition comprises:
determining if a number of final states is equal to or fewer than a number of non-final states, and
selecting the at least one final state to be included in the initial partition if the number of final states is equal to or fewer than the number of non-final states.

20. The computing device of claim 16, wherein the binary decision diagram comprises a first state and a final state, and wherein selecting a bit combination representing the individual character comprises:
traversing the binary decision diagram from the first state to the final state to generate the bit combination representing the individual character; and
selecting the state transition of the binary decision diagram based on the probability associated with the state transition of the binary decision diagram.
